(19) United States
(12) Patent Application Publication
(10) Pub. No.: US 2013/0247939 A1
(43) Pub. Date: Sep. 26, 2013

(54) METHOD FOR AUTOMATED, CLOSED LOOP CLEANING OF TANKS

(71) Applicant: TURNKEY CLEANING SERVICES, LLC, LAFAYETTE, LA (US)

(72) Inventors: PEAK CHANTHAVONGSY, LAFAYETTE, LA (US); DALE MARTIN, LAFAYETTE, LA (US)

(21) Appl. No.: 13/850,723

(22) Filed: Mar. 26, 2013

Related U.S. Application Data
(60) Provisional application No. 61/615,522, filed on Mar. 26, 2012.

(51) Int. Cl. B08B 9/093

(52) U.S. Cl. CPC B08B 9/093
USPC 134/21; 134/22.1; 134/22.19

(57) ABSTRACT

A method for cleaning tanks and other containers including, but not necessarily limited to, tanks associated with land-based drilling rigs and/or used in connection with hydraulic fracturing operations. Recoverable liquids and associated solids are first removed from a tank to be cleaned. A cleaning solution is prepared in a weir tank and sprayed into a tank to be cleaned. Sprayed cleaning solution, together with any debris or residue from the tank being cleaned, is pumped back to the weir tank and recycled for further cleaning.

### CROSS REFERENCES TO RELATED APPLICATION

Priority of U.S. Provisional Patent Application Ser. No. 61/615,522, filed Mar. 26, 2012, incorporated herein by reference, is hereby claimed.

### STATEMENTS AS TO THE RIGHTS TO THE INVENTION MADE UNDER FEDERALLY SPONSORED RESEARCH AND DEVELOPMENT

None

### BACKGROUND OF THE INVENTION

1. Field of the Invention

The present invention pertains to a method for cleaning tanks and other containers including, but not necessarily limited to, tanks associated with land-based drilling rigs and tanks used in connection with hydraulic fracturing operations.

2. Brief Description of the Prior Art

Tanks, containers and other similar enclosures are commonly used to store fluids that are utilized in any number of different applications. Tanks of varying sizes and shapes are frequently used to store liquids in connection with numerous industries including, but not necessarily limited to, the oil and gas industry.

With respect to oil and gas operations, tanks are frequently utilized on land-based drilling rigs to store and/or transport a multitude of different fluids including, without limitation, drilling fluids. Such drilling fluids often contain chemicals and/or other additives designed to adjust or control certain characteristics of said fluids. Caution must typically be taken during storage, use and/or handling of such fluids, since many such drilling fluids and/or associated chemicals or additives can be harmful to personnel and the surrounding environment.

Different drilling, treating and/or producing operations may also require different types of fluids having various characteristics and/or properties. In such cases, tanks are also typically used to store and/or transport such fluids. Limited tank capacity on a drilling rig or other location frequently necessitates using the same tanks to store multiple different fluids. However, because such different types of fluids may not be compatible with one another, it is frequently necessary to clean such tanks before switching out fluids to be stored in such tanks.

One common operation requiring the use of fluids and associated tanks is hydraulic fracturing, commonly referred to as “fracking”. So-called “frac tanks” are frequently used to store fluids used in hydraulic fracturing operations. Such frac tanks generally must also be cleaned after use.

Cleaning tanks (including, without limitation, drilling rig or frac tanks) can often prove to be a difficult, expensive and time consuming process. Personnel are often utilized to manually clean such tanks which can be very physically challenging, especially on hot days when temperatures inside such tanks can be extremely high (and ventilation within such tanks can be very poor). Frequently, personnel must enter a tank with a pressure washer wand or other sprayer; waste water and product are then removed using a “super sucker”, “gap vac” or other suction means. Prolonged manual cleaning of tanks raises safety concerns, because personnel inside such tanks are frequently exposed to fluid residue, chemicals, toxins and/or contaminants that may be present within such tanks.

Regardless of the method and/or apparatus used, virtually all prior art means of cleaning tanks utilize wash water or some other fluid(s) to rinse drilling fluid residue, solids and/or other debris from the inner surfaces of such tanks. After being used, the wash water effluent or other fluid typically contains significant amounts of solids or other contaminants. As a result, such effluent typically cannot be dumped or otherwise disposed of where the tank is located due to environmental concerns.

In most cases, in order to avoid environmental contamination and comply with applicable governmental regulations, such wash water or other effluent fluid must be transported to another location for off-site disposal. In order to accomplish such off-site disposal, effluent must be loaded into boxes, tanks or other storage containers for transportation away from the tank being cleaned. Generally, the greater the volume of the wash effluent, the greater the cost of such disposal.

Existing tank cleaning methods can result in dramatic increases in water utilization, chemical use, energy consumption, and waste (including wash effluent) disposal costs. Such operations can be costly, time consuming, labor intensive and detrimental to the environment by generating excessive amount of wash effluent throughout the course of tank cleaning operations.

Thus, there is a need for an improved method for cleaning tanks. Such improved method should reduce waste water consumption, cleaning time, and safety risks inherent with existing cleaning methods.

### SUMMARY OF THE PRESENT INVENTION

In accordance with the method of the present invention, each tank to be cleaned is initially assessed for recoverable fluids, as well as the safest and most efficient cleaning method and best practice for removing residual fluids and cleaning of such tank. Any free drilling mud, other fluid or solids remaining in such tank is first removed and saved; recoverable fluids suitable for reuse or other salvage may have a significant economic value.

After such liquids and solids have been removed from a tank to be cleaned, gun lines associated with such tank and/or a related fluid system are flushed. Thereafter, a cleaning solution is prepared. In the preferred embodiment, said cleaning solution can be prepared in a weir tank and is sometimes referred to herein as “wash water”—however, it is to be observed that such cleaning solution does not necessarily have to be comprised (completely or partially) of water.

When frac tanks are cleaned, automated tools are typically used throughout the entire cleaning process. When such automated tools are utilized, wash water is beneficially recycled and re-used until substantially all product residues have been adequately removed from internal surfaces of such tanks. Additional cleaning may be accomplished using a hose and/or spray nozzle to remove any debris or residue remaining within such tanks (such as under gun lines not adequately cleaned by such automated tools). A steam cleaning unit can also be used to clean the inner surfaces of said tanks. When rig tanks are being cleaned, automated tools are typically used only if such rig tanks are enclosed or determined to be safe for use of such automated tools.

For so-called shale shakers, once it is determined that all recoverable drilling fluids have been removed from sand traps and settling tanks of such shale shakers, flow lines from a rig floor are initially flushed. A hose with one or more nozzles can be used to clean inside such shale shakers and troughs. A hydraulic sump pump, air diaphragm pump or other pump can be beneficially used to return wash water back into a weir tank for re-use. A closed loop washing process is repeated through removal of solids to eliminate the need for additional wash water. Once substantially all solids have been removed from a shale shaker and troughs, a final cleaning/rinse can be performed using a steam cleaning unit.

When substantially all recoverable mud is removed from a rig's active and reserve tanks, a hose with at least one nozzle can be used to remove any remaining debris and/or residue from walls, floors and internal surfaces of such tanks. A pump, such as a hydraulic sump pump or air diaphragm pump, can be used to return recycled wash water back into the weir tank for re-use. The process is repeated for all tanks until substantially all debris and/or residues have been satisfactorily removed. Thereafter, an additional cleaning of such tanks can be performed using a steam cleaning unit.

The recirculation process and reuse of wash solution is a focal point of the automated and closed loop system of the present invention, and plays a central role in the cleaning process of the present invention. Upon completion of a cleaning job, wash water and/or any remaining product inside a well tank can be removed using a vacuum truck or other beneficial means, and then transported to a designated waste disposal facility.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed. Further, dimensions, materials and part names are provided for illustration purposes only and not limitation.

FIG. 1 depicts a flow diagram of an embodiment of the closed loop cleaning method of the present invention.

### DETAILED DESCRIPTION OF A PREFERRED EMBODIMENT OF THE INVENTION

The present invention comprises a method for cleaning tanks including, without limitation, frac tanks and tanks associated with operations on land-based drilling rigs. The cleaning method of the present invention reduces waste water consumption, cleaning time, and safety risks inherent with existing tank cleaning operations.

In accordance with the method of the present invention, a tank to be cleaned is initially assessed for recoverable fluids, as well as the safest and most efficient cleaning method and best practice for removing residual fluids and cleaning of such tank. Substantially all drilling mud and/or other fluid remaining in such a tank is first removed and saved; recoverable fluids suitable for reuse or other salvage can be segregated and saved, as such fluids may have economic value.

Fluids (including residual fluids) present on walls, floors or other internal surfaces of such tank can then removed with a squeegee or other similar method. Such residual fluids can be beneficially pumped or otherwise directed into a vacuum truck or holding tank. Recovery of such fluids can result in reduction of time and waste water used for cleaning.

After all such liquids (and any accompanying solids) have been removed from a tank to be cleaned, gun lines are flushed. In most cases, such gun lines are flushed for both rig tanks and frac tanks. In certain instances, a flex lance can be used to clean such gun lines to ensure all residual liquids and associated solids have been removed from said gun lines and inner surfaces. Additionally, in certain circumstances, wash water used to flush such gun lines can be directed back to a circulating tank for reuse.

In the preferred embodiment, a cleaning fluid is prepared in a weir tank according to specific requirements for particular cleaning operations. Such cleaning fluid can then be sprayed or otherwise discharged into a tank being cleaned in order to wash internal surfaces of such tank. In certain cases, such cleaning fluid can be sprayed into a tank using an automated spray nozzle that can be mounted or otherwise installed within said tank. After such cleaning fluid has been sprayed into said tank, such cleaning fluid can be recaptured (typically via drainage, suction, siphoning or other means) and redirected to said weir tank as part of a close-loop fluid system.

In many cases, such cleaning fluid can include soap, surfactant or other cleaning agent or additive(s) specifically adapted to satisfy particular tank, fluid or operational conditions. Often, especially when automated spray nozzles or other tools are used to direct cleaning fluids at internal tank surfaces, the concentration of such soap, surfactant or other cleaning agents can be added or otherwise adjusted as a cleaning operation unfolds.

By way of illustration, but not limitation, only 25% of total soap content may be initially mixed with cleaning fluid in order to reduce excessive foam and suds. After a predetermined period of time has elapsed, or a predetermined amount of cleaning fluid has been sprayed, the remaining 75% of such total soap content can be added to said cleaning fluid (typically via said weir tank). It is to be observed that this example is illustrative only, and such percentages or additives can be adjusted to meet particular job parameters.

As noted above, cleaning fluid can be applied to the interior of tanks either by manual spraying (through a hose or nozzle) or automated nozzles or spraying/cleaning tools. Cleaning fluid can also be applied separately or by a combination of such methods.

When frac tanks are being cleaned, automated spraying tools are typically used throughout substantially the entire cleaning process. Such automated spraying nozzles or other tools are inserted into said frac tank and mounted or otherwise placed for maximum spray coverage and efficiency. Cleaning fluid is pumped from such weir tank through said automated spraying tools, and then recovered from said frac tank and redirected to said weir tank; such cleaning fluid is beneficially recycled and re-used until substantially all product residues have been adequately removed from internal surfaces of said frac tank.

If desired, an additional cleaning can be performed using such recycled cleaning fluid and a hose or other spray nozzle to specifically direct cleaning fluid into any hidden or inaccessible areas within a tank such as, for example, under gun lines or other places that may not be reachable by spray from automated spray tools. After substantially all debris or residues have been removed from a tank being cleaned, an additional cleaning can be performed using a steam cleaning unit (that is, directing steam at internal surfaces of said tank and collecting any residual or collected fluids).

By contrast, when drilling rig tanks are being cleaned, automated spraying tools are typically used only if such tanks are enclosed or determined to be safe for use of such automated spraying tools. Cleaning of drilling rig tanks generally comprises cleaning of a rig's active and reserve mud tank's, shale shakers and related equipment, as well as intermediary lines (such as lines of a rig's active mud system) extending between such components.

Many drilling rigs, including land-based rigs, are equipped with separation equipment known as shale shakers. Such shale shakers are essentially screens, often arranged in tiered or flat disposition relative to each other, used to separate drill cuttings and/or solids from the drilling mud. Further, such screens are often made to vibrate in order to increase the quality of such separation. Bulk drilling generally mud falls through the screens by gravity, while the predominantly solid cuttings generally pass over the end of the screens.

When cleaning such shale shakers, substantially all salvageable mud or other fluid (together with any accompanying solids) should first be recovered from sand traps and/or settling tanks of such shale shakers. Thereafter, flow line(s) from rig floor through a gumbo box (or other pipes or lines of a rig's active mud system) can be flushed with water or cleaning fluid, with debris or residual fluid being captured and collected.

Hoses having one or more spray nozzles can be used to spray cleaning fluid inside shale shakers and troughs including, without limitation, directing of cleaning fluid at internal surfaces thereof. Hydraulic sump pumps or air diaphragm pumps can be used to suction and return sprayed cleaning fluid from the inside of such shale shakers/troughs back to a weir tank. This closed loop process is repeated through the cleaning of shale shakers, troughs and associated equipment including, without limitation, removal of solids. Once substantially all solids have been removed from a shale shaker, troughs and associated equipment, a final cleaning of such components can be performed using a steam sprayer

When cleaning a rig's active and reserve tanks (such as, for example, active and reserve tanks used as part of a drilling rig's mud system) substantially all salvageable mud or other fluid (together with any accompanying solids) should first be removed and recovered from such tanks. A hose having at least one sprayer nozzle can then be used to spray cleaning fluid within such active and reserve tanks to remove debris and/or residue from walls, floors and internal surfaces of such tanks.

Hydraulic sump pumps or air diaphragm pumps can be used to suction and return sprayed cleaning fluid from the inside of such tanks back to a weir tank. This closed loop process is beneficially utilized throughout the cleaning of such tanks. Once substantially all debris or residue is removed from such tanks through such closed loop cleaning, a final cleaning of such components can be performed using a steam sprayer.

Upon completion of cleaning operations, recovered cleaning fluids and/or debris, residue, solids or other materials inside a well tank can be suctioned or otherwise removed from said weir tank and transported to a designated waste disposal facility.

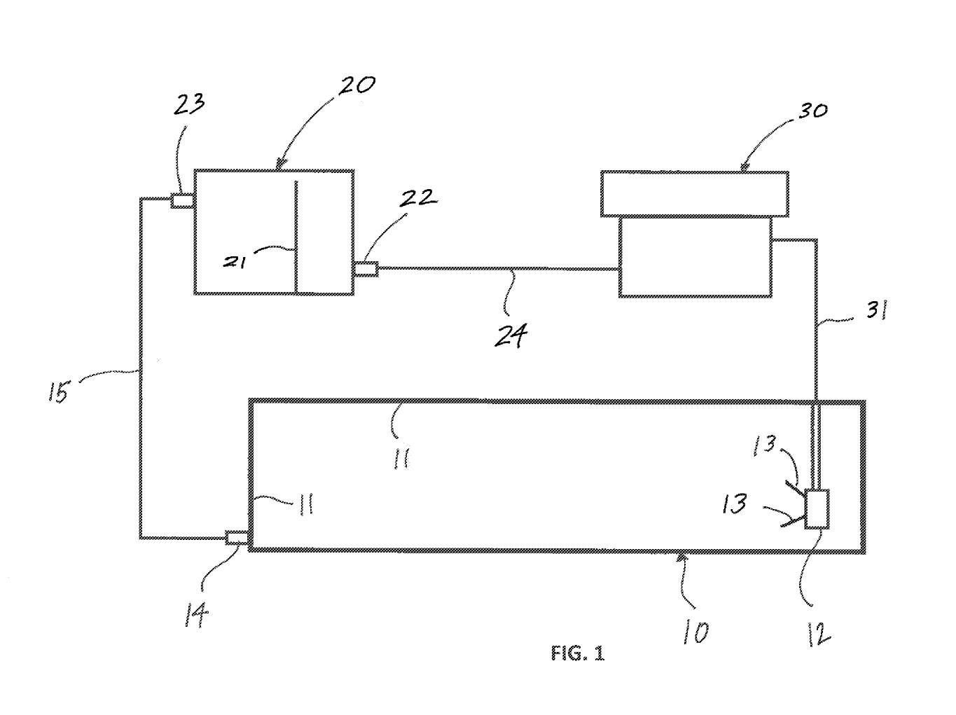

Referring to the drawings, FIG. 1 depicts a flow diagram of an embodiment of the closed loop cleaning method of the present invention being used to clean a frac tank 10. In the preferred embodiment, a cleaning fluid is prepared in a weir tank 20 according to specific requirements for particular cleaning operations. Weir tank 20 can have internal baffle 21, or a pump or other beneficial equipment (not shown in FIG. 1) well known by those having skill in the art of weir tanks.

Such cleaning fluid can then be sent from outlet 22 of weir tank 20 via line 24 to pump assembly 30. Said pump assembly 30 is used to pump said cleaning fluid to tank 10 via pump assembly output line 31. Such cleaning fluid pumped from pump assembly 30 can then be sprayed or otherwise discharged into frac tank 10 being cleaned in order to wash internal surfaces 11 of such tank. As depicted in FIG. 1, such cleaning fluid can be sprayed into tank 10 using an automated spray assembly 12 having rotating spray nozzles 13 that are well known in the art. Spray assembly 12 can be mounted or otherwise installed within said tank 10.

After such cleaning fluid has been sprayed into said tank 10, such cleaning fluid can be recaptured (typically via drainage, suction, siphoning or other means). As depicted in FIG. 1, such cleaning fluid is recovered though drain line 14 and redirected to said weir tank 20 via line 15 and weir tank inlet 23, as part of a close-loop fluid system. Cleaning fluid recovered from frac tank 10 and redirected to said weir tank 20 is beneficially recycled and re-used until substantially all product residues have been adequately removed from internal surfaces of said frac tank.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A method for cleaning a frac tank having an interior comprising:
a) preparing a cleaning fluid within a weir tank;
b) pumping said cleaning fluid through at least one nozzle disposed in the interior of said tank;
c) spraying internal surfaces of said frac tank with said cleaning fluid; and
d) pumping said cleaning fluid from the interior of said frac tank to said weir tank.

2. The method of claim 1, further comprising removing substantially all free liquids and solids from said tank before pumping said cleaning fluid in the interior of said tank.

3. The method of claim 1, further comprising spraying steam against internal surfaces of said frac tank.

4. The method of claim 3, further comprising:
a) collecting condensed water from the interior of said frac tank; and
b) pumping said water to said weir tank.

5. The method of claim 1 further comprising suctioning said cleaning fluid from said frac tank.

6. The method of claim 1, wherein said cleaning fluid contains soap.

7. The method of claim 6, wherein the concentration of said soap in said cleaning fluid is increased over time.

8. The method of claim 1, wherein said at least one nozzle disposed in the interior of said tank comprises an automated spray nozzle.

9. The method of claim 1, wherein said at least one nozzle disposed in the interior of said tank comprises a hose nozzle.

10. A method for cleaning tanks of a land-based drilling rig comprising:
a) removing substantially all free liquids and solids from said rig tanks;
b) preparing a cleaning fluid within a weir tank;
c) pumping said cleaning fluid through at least one nozzle disposed in the interior of said tanks;
d) spraying internal surfaces of said tanks with said cleaning fluid; and
e) pumping said cleaning fluid from the interior of said tanks to said weir tank.

11. The method of claim 10, further comprising flushing all lines of said rig's mud system.

12. The method of claim 10, further comprising spraying steam against said internal surfaces of said tanks.

13. The method of claim 12, further comprising:
a) collecting condensed water from the interior of said tank; and
b) pumping said water to said weir tank.

14. The method of claim 10, further comprising cleaning a shale shaker

15. The method of claim 14, further comprising:
a) removing substantially all free liquids and solids from said shale shaker;
b) pumping said cleaning fluid through at least one nozzle disposed in the interior of said shale shaker;
c) spraying internal surfaces of said shale shaker with said cleaning fluid; and
d) pumping said cleaning fluid from the interior of said shale shaker to said weir tank.
